(19) United States
(12) Patent Application Publication
(10) Pub. No.: US 2025/0022470 A1
(43) Pub. Date: Jan. 16, 2025

(54) SPEAKER IDENTIFICATION METHOD, SPEAKER IDENTIFICATION DEVICE, AND NON-TRANSITORY COMPUTER READABLE RECORDING MEDIUM STORING SPEAKER IDENTIFICATION PROGRAM

(71) Applicant: Panasonic Intellectual Property Corporation of America, Torrance, CA (US)

(72) Inventor: Misaki DOI, Osaka (JP)

(21) Appl. No.: 18/898,006

(22) Filed: Sep. 26, 2024

Related U.S. Application Data
(63) Continuation of application No. PCT/JP2023/007820, filed on Mar. 2, 2023.

(30) Foreign Application Priority Data
Mar. 29, 2022 (JP) 2022-053033

(51) Int. Cl. G10L 17/06; G10L 17/02

(52) U.S. Cl. CPC G10L 17/06; G10L 17/02

(57) ABSTRACT

A speaker identification device acquires voice data to be identified, acquires a plurality of pieces of registered voice data that are registered in advance, calculates a similarity between the voice data to be identified and each of the plurality of pieces of registered voice data, selects a registered speaker of registered voice data corresponding to a highest similarity from among a plurality of calculated similarities, determines, based on the plurality of calculated similarities, whether or not the voice data to be identified is suitable for speaker identification, determines, based on the highest similarity, whether or not to identify the selected registered speaker as a speaker to be identified of the voice data to be identified in a case where the voice data to be identified is determined to be suitable for the speaker identification, and outputs the identification result.

### FIELD OF INVENTION

The present disclosure relates to a technique for identifying a speaker.

### BACKGROUND ART

For example, Patent Literature 1 discloses a noise suppressed voice recognition device that extracts an acoustic feature amount from input voice in units of frames, detects a voice section of the input voice, detects a noise section for each noise type, selects a noise suppression method, generates an acoustic feature amount in which an acoustic feature amount of noise is suppressed by the selected noise suppression method, and performs voice recognition using the generated acoustic feature amount.

However, in a case where noise of input voice is suppressed by signal processing as in the above-described conventional technique, there is a possibility that a personal characteristic of a speaker is distorted, and as a result, there is a possibility that accuracy of speaker recognition is lowered. For this reason, in the above-described conventional technique, further improvement has been required.

Patent Literature 1: JP 2016-180839 A

### SUMMARY OF THE INVENTION

The present disclosure has been made to solve the above problem, and an object of the present disclosure is to provide a technique that can improve accuracy of identifying which of a plurality of speakers registered in advance a speaker to be identified is, without increasing a calculation amount.

A speaker identification method according to the present disclosure is a speaker identification method in a computer, the speaker identification method including acquiring voice data to be identified, acquiring a plurality of pieces of registered voice data that are registered in advance, calculating a similarity between the voice data to be identified and each of the plurality of pieces of registered voice data, selecting a registered speaker of registered voice data corresponding to a highest similarity from among a plurality of calculated similarities, determining, based on the plurality of calculated similarities, whether or not the voice data to be identified is suitable for speaker identification, determining, based on the highest similarity, whether or not to identify the selected registered speaker as a speaker to be identified of the voice data to be identified in a case where the voice data to be identified is determined to be suitable for the speaker identification, and outputting an identification result.

According to the present disclosure, it is possible to improve accuracy of identifying which of a plurality of speakers registered in advance a speaker to be identified is without increasing a calculation amount.

### BRIEF DESCRIPTION OF THE DRAWINGS

FIG. 1 is a diagram illustrating a configuration of a speaker identification system according to a first embodiment of the present disclosure.

FIG. 2 is a first flowchart for explaining operation of speaker identification processing of a speaker identification device according to the first embodiment.

FIG. 3 is a second flowchart for explaining operation of the speaker identification processing of the speaker identification device according to the first embodiment.

FIG. 4 is a diagram illustrating a configuration of the speaker identification system according to a second embodiment of the present disclosure.

FIG. 5 is a first flowchart for explaining operation of the speaker identification processing of the speaker identification device according to the second embodiment.

FIG. 6 is a second flowchart for explaining operation of the speaker identification processing of the speaker identification device according to the second embodiment.

FIG. 7 is a diagram illustrating a configuration of the speaker identification system according to a third embodiment of the present disclosure.

FIG. 8 is a first flowchart for explaining operation of the speaker identification processing of the speaker identification device according to the third embodiment.

FIG. 9 is a second flowchart for explaining operation of the speaker identification processing of the speaker identification device according to the third embodiment.

### DETAILED DESCRIPTION

### Knowledge Underlying Present Disclosure

Conventionally, there has been known speaker identification that acquires input voice data of a speaker to be identified and identifies which of a plurality of speakers registered in advance a speaker to be identified is based on the acquired input voice data and a plurality of pieces of registered voice data registered in advance. In the conventional speaker identification, a similarity score between a feature amount of input voice data of a speaker to be identified and a feature amount of registered voice data of a plurality of registered speakers is calculated. Then, a registered speaker of registered voice data corresponding to a highest similarity score among a plurality of calculated similarity scores is identified as a speaker to be identified.

However, in the conventional speaker identification, in a case where input voice data of a speaker to be identified includes noise or a case where input voice data does not include voice of a speaker to be identified, a speaker identification result is output, but accuracy of speaker identification using the input voice data including noise or the input voice data not including voice of the speaker to be identified is low.

On the other hand, according to the noise suppressed voice recognition device of Patent Literature 1, a voice section of input voice is detected, and voice recognition is performed while noise in the voice section is suppressed.

However, in a case where noise of input voice is suppressed by signal processing as in the above-described conventional technique, there is a possibility that a personal characteristic of a speaker is distorted, and as a result, there is a possibility that accuracy of speaker recognition is lowered. Further, signal processing for suppressing noise of input voice requires a large calculation amount.

To solve the above problems, a technique below is disclosed.
(1) A speaker identification method according to one aspect of the present disclosure is a speaker identification method in a computer, the speaker identification method including acquiring voice data to be identified, acquiring a plurality of pieces of registered voice data that are registered in advance, calculating a similarity between the voice data to be identified and each of the plurality of pieces of registered voice data, selecting a registered speaker of registered voice data corresponding to a highest similarity from among a plurality of calculated similarities, determining, based on the plurality of calculated similarities, whether or not the voice data to be identified is suitable for speaker identification, determining, based on the highest similarity, whether or not to identify the selected registered speaker as a speaker to be identified of the voice data to be identified in a case where the voice data to be identified is determined to be suitable for the speaker identification, and outputting an identification result.

According to this configuration, a similarity between voice data to be identified and each of a plurality of pieces of registered voice data is calculated, and whether or not the voice data to be identified is suitable for speaker identification is determined based on the plurality of calculated similarities. Then, in a case where it is determined that the voice data to be identified is suitable for speaker identification, it is determined whether or not to identify the selected registered speaker as the speaker to be identified of the voice data to be identified based on a highest similarity.

A calculation amount of processing for calculating a plurality of similarities is smaller than a calculation amount of signal processing for suppressing noise included in the voice data to be identified. Further, since it is determined whether or not the voice data to be identified is suitable for speaker identification based on the plurality of calculated similarities, signal processing for suppressing noise that may distort a personal characteristic of a speaker is not performed on the voice data to be identified. Therefore, it is possible to improve accuracy of identifying which of a plurality of speakers registered in advance a speaker to be identified is without increasing a calculation amount.
(2) In the speaker identification method according to (1), in determination as to whether or not the voice data to be identified is suitable for the speaker identification, whether or not a highest similarity among the plurality of calculated similarities is higher than a first threshold may be determined, and in a case where the highest similarity is determined to be higher than the first threshold, the voice data to be identified may be determined to be suitable for the speaker identification.

According to this configuration, by comparing a highest similarity among a plurality of calculated similarities with the first threshold, it is possible to easily determine whether or not the voice data to be identified is suitable for speaker identification.
(3) In the speaker identification method according to (1), in determination as to whether or not the voice data to be identified is suitable for the speaker identification, a variance value of the plurality of calculated similarities may be calculated, whether or not the calculated variance value is higher than a first threshold may be determined, and in a case where the variance value is determined to be higher than the first threshold, the voice data to be identified may be determined to be suitable for the speaker identification.

In a case where the voice data to be identified is not suitable for speaker identification, the calculated variance value of a plurality of similarities is low. For this reason, by comparing the calculated variance value of a plurality of similarities with the first threshold, it is possible to easily determine whether or not the voice data to be identified is suitable for speaker identification.
(4) In the speaker identification method according to (2) or (3), in determination as to whether or not to identify the selected registered speaker as a speaker to be identified of the voice data to be identified, whether or not a highest similarity among the plurality of calculated similarities is higher than a second threshold higher than the first threshold may be determined, and in a case where the highest similarity is determined to be higher than the second threshold, the selected registered speaker may be identified as the speaker to be identified of the voice data to be identified.

According to this configuration, whether or not a selected registered speaker is a speaker to be identified of voice data to be identified can be easily identified by comparing a highest similarity among a plurality of calculated similarities with the second threshold higher than the first threshold.
(5) In the speaker identification method according to (1), the plurality of pieces of registered voice data may include a plurality of pieces of first registered voice data in which voice uttered by a plurality of registered speakers to be identified is registered in advance, and a plurality of pieces of second registered voice data in which voice uttered by a plurality of other registered speakers other than the plurality of registered speakers to be identified is registered in advance, in calculation of the similarity, a first similarity between the voice data to be identified and each of the plurality of pieces of first registered voice data may be calculated, and a second similarity between the voice data to be identified and each of the plurality of pieces of second registered voice data may be calculated, in selection of the registered speaker, a registered speaker of first registered voice data corresponding to a highest first similarity among a plurality of calculated first similarities may be selected, and in determination as to whether or not the voice data to be identified is suitable for the speaker identification, whether or not a highest first similarity or a highest second similarity among the plurality of calculated first similarities and the plurality of calculated second similarities is higher than a first threshold may be determined, and in a case where the highest first similarity or the highest second similarity is determined to be higher than the first threshold, the voice data to be identified may be determined to be suitable for the speaker identification.

In a case where voice data to be identified is speaker identifiable, there is a high possibility that the voice data to be identified is similar to any of a plurality of pieces of registered voice data as the number of pieces of a plurality of registered voice data increases. In view of the above, it is possible to reliably determine whether or not voice data to be identified is suitable for speaker identification by using not only a plurality of first similarities calculated from a plurality of pieces of first registered voice data in which voice uttered by a plurality of registered speakers to be identified are registered in advance, but also a plurality of second similarities calculated from a plurality of pieces of second registered voice data in which voice uttered by a plurality of other registered speakers other than a plurality of registered speakers to be identified are registered in advance.
(6) In the speaker identification method according to (5), the plurality of pieces of second registered voice data may not include noise and may include only the voice uttered by the other registered speakers.

According to this configuration, a second similarity between voice data to be identified and each of a plurality of pieces of second registered voice data can be stably calculated by using a plurality of pieces of second registered voice data including only clean voice not including noise.
(7) In the speaker identification method according to (5) or (6), in determination as to whether or not to identify the selected registered speaker as a speaker to be identified of the voice data to be identified, whether or not a highest first similarity among the plurality of calculated first similarities is higher than a second threshold higher than the first threshold may be determined, and in a case where the highest first similarity is determined to be higher than the second threshold, the selected registered speaker may be identified as the speaker to be identified of the voice data to be identified.

According to this configuration, whether or not a selected registered speaker is a speaker to be identified of voice data to be identified can be easily identified by comparing a highest first similarity among a plurality of calculated first similarities with the second threshold higher than the first threshold.
(8) The speaker identification method according to any one of (1) to (7) may further include outputting an error message prompting the speaker to be identified to reinput the voice data to be identified in a case where the voice data to be identified is determined not to be suitable for the speaker identification.

According to this configuration, in a case where voice data to be identified is not suitable for speaker identification, it is possible to prompt a speaker to be identified to reinput the voice data to be identified, and speaker identification can be performed using the reinput voice data to be identified.
(9) In the speaker identification method according to any one of (1) to (7), in acquisition of the voice data to be identified, the voice data to be identified obtained by cutting out a predetermined section from voice data uttered by the speaker to be identified may be acquired, and the speaker identification method may further include acquiring another piece of voice data to be identified obtained by cutting out a section different from the predetermined section from the voice data in a case where the voice data to be identified is determined not to be suitable for the speaker identification.

For example, in a case where voice of the speaker to be identified is not included in voice data to be identified in a section cut out first, it is determined that the voice data to be identified is not suitable for speaker identification. In this case, another piece of voice data to be identified obtained by cutting out a section different from the first section from the voice data is acquired. Therefore, in a case where it is determined that voice data to be identified is not suitable for speaker identification, speaker identification can be performed by using another piece of voice data to be identified.

Further, the present disclosure can be realized not only as the speaker identification method for performing characteristic processing as described above, but also as a speaker identification device or the like having a characteristic configuration corresponding to the characteristic method executed by the speaker identification method. Further, the present disclosure can also be realized as a computer program that causes a computer to execute the characteristic processing included in the speaker identification method. Therefore, another aspect below can also achieve an effect similar to that in the above speaker identification method.
(10) A speaker identification device according to another aspect of the present disclosure includes an identification target voice data acquisition part that acquires voice data to be identified, a registered voice data acquisition part that acquires a plurality of pieces of registered voice data that are registered in advance, a calculation part that calculates a similarity between the voice data to be identified and each of the plurality of pieces of registered voice data, a selection part that selects a registered speaker of registered voice data corresponding to a highest similarity from among a plurality of calculated similarities, a similarity determination part that determines, based on the plurality of calculated similarities, whether or not the voice data to be identified is suitable for speaker identification, a speaker determination part that determines, based on the highest similarity, whether or not to identify the selected registered speaker as a speaker to be identified of the voice data to be identified in a case where the voice data to be identified is determined to be suitable for the speaker identification, and an output part that outputs an identification result.
(11) A speaker identification program according to another aspect of the present disclosure causes a computer to function to acquire voice data to be identified, acquire a plurality of pieces of registered voice data that are registered in advance, calculate a similarity between the voice data to be identified and each of the plurality of pieces of registered voice data, select a registered speaker of registered voice data corresponding to a highest similarity from among a plurality of calculated similarities, determine, based on the plurality of calculated similarities, whether or not the voice data to be identified is suitable for speaker identification, determine, based on the highest similarity, whether or not to identify the selected registered speaker as a speaker to be identified of the voice data to be identified in a case where the voice data to be identified is determined to be suitable for the speaker identification, and output an identification result.
(12) A non-transitory computer-readable recording medium according to another aspect of the present disclosure records a speaker identification program, and the speaker identification program causes a computer to function to acquire voice data to be identified, acquire a plurality of pieces of registered voice data that are registered in advance, calculate a similarity between the voice data to be identified and each of the plurality of pieces of registered voice data, select a registered speaker of registered voice data corresponding to a highest similarity from among a plurality of calculated similarities, determine, based on the plurality of calculated similarities, whether or not the voice data to be identified is suitable for speaker identification, determine, based on the highest similarity, whether or not to identify the selected registered speaker as a speaker to be identified of the voice data to be identified in a case where the voice data to be identified is determined to be suitable for the speaker identification, and output an identification result.

An embodiment of the present disclosure will be described below with reference to the accompanying drawings. Note that the embodiment below is an example of embodiment of the present disclosure, and is not intended to limit the technical scope of the present disclosure.

### First Embodiment

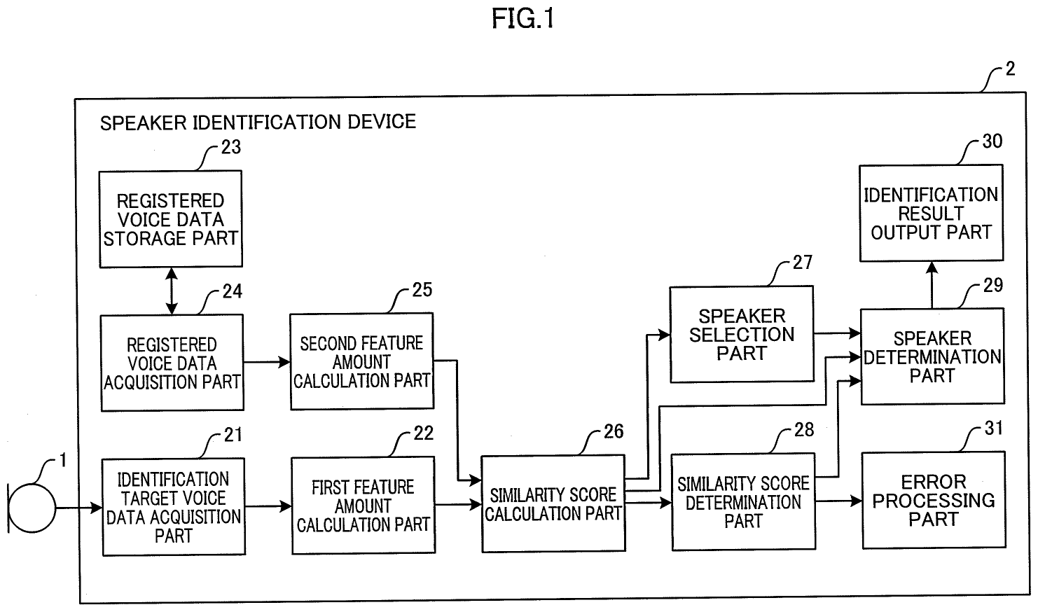

FIG. 1 is a diagram illustrating a configuration of a speaker identification system according to a first embodiment of the present disclosure.

The speaker identification system illustrated in FIG. 1 includes a microphone 1 and a speaker identification device 2. Note that the speaker identification device 2 may or may not include the microphone 1.

The microphone 1 collects voice uttered by a speaker, converts the voice into voice data, and outputs the voice data to the speaker identification device 2. When a speaker is identified, the microphone 1 outputs voice data to be identified uttered by the speaker to the speaker identification device 2. Further, when voice data is registered in advance, the microphone 1 may output voice data to be registered uttered by a speaker to the speaker identification device 2. The microphone I may be fixed or movable in a space where a speaker to be identified is present.

The speaker identification device 2 includes an identification target voice data acquisition part 21, a first feature amount calculation part 22, a registered voice data storage part 23, a registered voice data acquisition part 24, a second feature amount calculation part 25, a similarity score calculation part 26, a speaker selection part 27, a similarity score determination part 28, a speaker determination part 29, an identification result output part 30, and an error processing part 31.

Note that the identification target voice data acquisition part 21, the first feature amount calculation part 22, the registered voice data acquisition part 24, the second feature amount calculation part 25, the similarity score calculation part 26, the speaker selection part 27, the similarity score determination part 28, the speaker determination part 29, the identification result output part 30, and the error processing part 31 are realized by a processor. The processor includes, for example, a central processing unit (CPU) or the like.

The registered voice data storage part 23 is realized by a memory. The memory includes, for example, a read only memory (ROM), an electrically erasable programmable read only memory (EEPROM), or the like.

Note that the speaker identification device 2 may be, for example, a computer, a smartphone, a tablet computer, or a server.

The identification target voice data acquisition part 21 acquires voice data to be identified output from the microphone 1.

Note that in a case where the speaker identification device 2 is a server, the microphone 1 may be incorporated in a terminal such as a smartphone used by a speaker to be identified. In this case, the terminal may transmit voice data to be identified to the speaker identification device 2. The registered voice data acquisition part 24 may be, for example, a communication part, and may receive voice data to be identified transmitted by the terminal.

The first feature amount calculation part 22 calculates a feature amount of voice data to be identified acquired by the identification target voice data acquisition part 21. The feature amount is, for example, an i-vector. The i-vector is a feature amount of a low dimensional vector calculated from voice data by using factor analysis for a Gaussian mixture model (GMM) supervector. Note that a method of calculating an i-vector is a conventional technique, and thus detailed description of the method will be omitted. Further, the feature amount is not limited to an i-vector, and may be another feature amount such as an x-vector.

The registered voice data storage part 23 stores in advance a plurality of pieces of registered voice data associated with information on a speaker. The information on a speaker is, for example, a speaker ID or a name of the speaker for identifying the speaker.

Note that the speaker identification device 2 may further include a registration part that registers voice data to be registered output from the microphone 1 in the registered voice data storage part 23 as registered voice data, and an input receiving part that receives input of information on a speaker of the registered voice data. Then, the registration part may register registered voice data in the registered voice data storage part 23 in association with information on a speaker received by the input receiving part.

Further, utterance content of voice data to be identified and registered voice data may be any. Further, voice data to be identified and registered voice data may be a specific word or phrase.

The registered voice data acquisition part 24 acquires a plurality of pieces of registered voice data registered in advance in the registered voice data storage part 23. The registered voice data acquisition part 24 reads a plurality of pieces of registered voice data registered in advance from the registered voice data storage part 23.

The second feature amount calculation part 25 calculates a feature amount of a plurality of pieces of registered voice data acquired by the registered voice data acquisition part 24. The feature amount is, for example, an i-vector.

The similarity score calculation part 26 calculates a similarity score between a feature amount of voice data to be identified and each of feature amounts of a plurality of pieces of registered voice data. The similarity score is obtained by quantifying how much a feature amount of voice data to be identified is similar to a feature amount of registered voice data. The similarity score indicates similarity between a feature amount of voice data to be identified and a feature amount of registered voice data.

The similarity score calculation part 26 calculates a similarity score by using probabilistic linear discriminant analysis (PLDA). The similarity score is obtained by regarding a feature amount of utterance as being generated from a probabilistic model, and expresses whether or not two utterances are generated from the same generation model (the same speaker) by a log likelihood ratio. The similarity score is calculated based on a formula below.

Similarity score=log (likelihood of utterance of same speaker/likelihood of utterance of different speakers)

The similarity score calculation part 26 automatically selects a feature amount effective for speaker identification from 400 dimensional i-vector feature amounts, and calculates a log likelihood ratio as a similarity score. A similarity score calculated in a case where a speaker of voice data to be identified and a speaker of registered voice data are the same is higher than a similarity score calculated in a case where a speaker of voice data to be identified and a speaker of registered voice data are different. Further, a similarity score calculated from voice data to be identified that is not suitable for speaker identification including noise having volume larger than predetermined volume is lower than a similarity score calculated from voice data to be identified suitable for speaker identification including noise having volume smaller than predetermined volume.

Note that since calculation of a similarity score using PLDA is known, detailed description of the calculation will be omitted. Further, in the first embodiment, the similarity score calculation part 26 may calculate a similarity score between voice data to be identified and each of a plurality of pieces of registered voice data.

The speaker selection part 27 selects a registered speaker of registered voice data corresponding to a highest similarity score among a plurality of similarity scores calculated by the similarity score calculation part 26.

The similarity score determination part 28 determines whether or not voice data to be identified is suitable for speaker identification based on a plurality of similarity scores calculated by the similarity score calculation part 26. Here, the similarity score determination part 28 determines whether or not a highest similarity score among a plurality of similarity scores calculated by the similarity score calculation part 26 is higher than a first threshold. In a case of determining that the highest similarity score is higher than the first threshold, the similarity score determination part 28 determines that the voice data to be identified is suitable for speaker identification. On the other hand, in a case of determining that the highest similarity score is equal to or less than the first threshold, the similarity score determination part 28 determines that the voice data to be identified is not suitable for speaker identification.

In a case where voice data to be identified is determined to be suitable for speaker identification by the similarity score determination part 28, the speaker determination part 29 determines whether or not to identify a registered speaker selected by the speaker selection part 27 as a speaker to be identified of the voice data to be identified based on a highest similarity score. Here, the speaker determination part 29 determines whether or not a highest similarity score among a plurality of similarity scores calculated by the similarity score calculation part 26 is higher than a second threshold higher than the first threshold. In a case of determining that the highest similarity score is higher than the second threshold, the speaker determination part 29 determines to identify a registered speaker selected by the speaker selection part 27 as a speaker to be identified of the voice data to be identified. On the other hand, in a case of determining that the highest similarity score is equal to or less than the second threshold, the speaker determination part 29 determines not to identify a registered speaker selected by the speaker selection part 27 as a speaker to be identified of the voice data to be identified.

Note that, in the first embodiment, in a case where voice data to be identified is determined to be suitable for speaker identification by the similarity score determination part 28, the speaker determination part 29 may identify a registered speaker selected by the speaker selection part 27 as a speaker to be identified of the voice data to be identified. In this case, the speaker determination part 29 may identify a registered speaker selected by the speaker selection part 27 as a speaker to be identified of the voice data to be identified without determining whether or not a highest similarity score among a plurality of similarity scores calculated by the similarity score calculation part 26 is higher than the second threshold.

The identification result output part 30 outputs an identification result obtained by the speaker determination part 29. In a case where a selected registered speaker is identified as a speaker to be identified of voice data to be identified, the identification result output part 30 outputs an identification result including a name or speaker ID of the selected registered speaker. Further, the identification result may include a similarity score. Further, in a case where the selected registered speaker is not identified as a speaker to be identified of the voice data to be identified, the identification result output part 30 outputs an identification result indicating that the speaker to be identified of the voice data to be identified is identified as any of a plurality of registered speakers registered in advance.

The identification result output part 30 is, for example, a display or a loudspeaker, and in a case where a selected registered speaker is identified as a speaker to be identified of voice data to be identified, outputs a message indicating that the speaker to be identified of the voice data to be identified is the selected registered speaker from the display or the loudspeaker. On the other hand, in a case where the selected registered speaker is not identified as the speaker to be identified of the voice data to be identified, the identification result output part 30 outputs, from the display or the loudspeaker, a message indicating that the speaker to be identified of the voice data to be identified is not any of a plurality of registered speakers registered in advance.

Note that the identification result output part 30 may output an identification result obtained by the speaker determination part 29 to a device other than the speaker identification device 2. In a case where the speaker identification device 2 is a server, the identification result output part 30 may include, for example, a communication part, and may transmit an identification result to a terminal such as a smartphone used by a speaker to be identified. The terminal may include a display or a loudspeaker. A display or a loudspeaker of the terminal may output a received identification result.

In a case where the similarity score determination part 28 determines that voice data to be identified is not suitable for speaker identification, the error processing part 31 outputs an error message prompting a speaker to be identified to reinput voice data to be identified. The error processing part 31 outputs, for example, an error message “Please move closer to the microphone or speak in a quiet place”.

The error processing part 31 is, for example, a display or a loudspeaker, and in a case where the similarity score determination part 28 determines that voice data to be identified is not suitable for speaker identification, outputs, from the display or the loudspeaker, an error message prompting a speaker to be identified to reinput voice data to be identified.

Note that the error processing part 31 may output an error message prompting a speaker to be identified to reinput voice data to be identified to a device other than the speaker identification device 2. In a case where the speaker identification device 2 is a server, the error processing part 31 may include, for example, a communication part, and may transmit an error message to a terminal such as a smartphone used by a speaker to be identified. The terminal may include a display or a loudspeaker. A display or a loudspeaker of the terminal may output a received error message.

Next, operation of speaker identification processing of the speaker identification device 2 in the first embodiment of the present disclosure will be described.

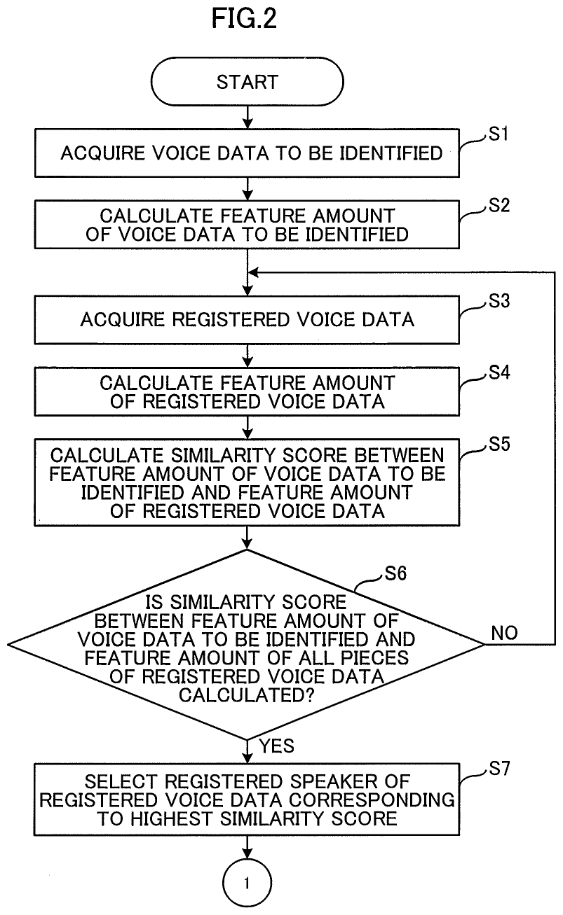

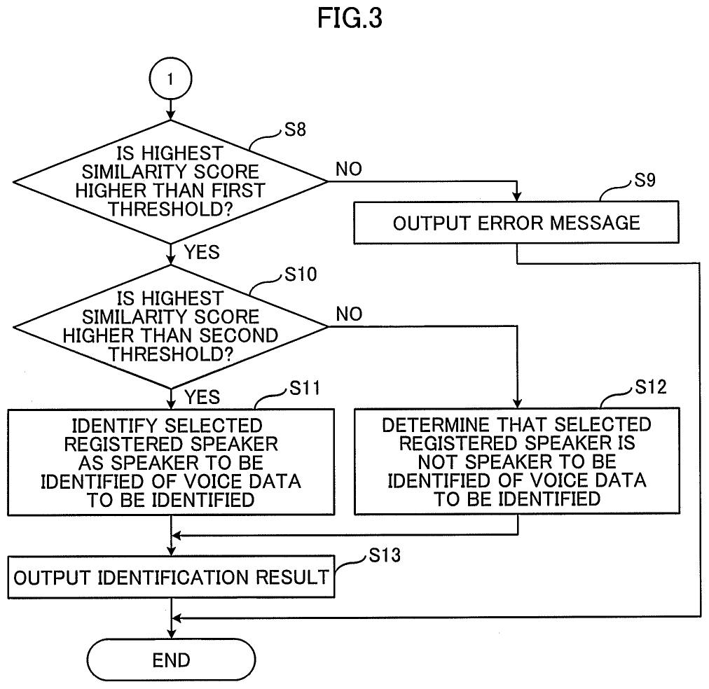

FIG. 2 is a first flowchart for explaining the operation of the speaker identification processing of the speaker identification device 2 in the first embodiment, and FIG. 3 is a second flowchart for explaining the operation of the speaker identification processing of the speaker identification device 2 in the first embodiment.

First, in Step S1, the identification target voice data acquisition part 21 acquires voice data to be identified output from the microphone 1. A speaker to be identified speaks toward the microphone 1. The microphone 1 collects voice uttered by the speaker to be identified and outputs voice data to be identified.

Next, in Step S2, the first feature amount calculation part 22 calculates a feature amount of the voice data to be identified acquired by the identification target voice data acquisition part 21.

Next, in Step S3, the registered voice data acquisition part 24 acquires registered voice data from the registered voice data storage part 23. At this time, the registered voice data acquisition part 24 acquires one piece of registered voice data from a plurality of pieces of registered voice data that are registered in the registered voice data storage part 23.

Next, in Step S4, the second feature amount calculation part 25 calculates a feature amount of registered voice data acquired by the registered voice data acquisition part 24.

Next, in Step S5, the similarity score calculation part 26 calculates a similarity score between a feature amount of voice data to be identified and a feature amount of registered voice data.

Next, in Step S6, the similarity score calculation part 26 determines whether or not a similarity score between a feature amount of voice data to be identified and a feature amount of all pieces of registered voice data stored in the registered voice data storage part 23 is calculated. Here, in a case where it is determined that a similarity score between a feature amount of voice data to be identified and a feature amount of all pieces of registered voice data is not calculated (NO in Step S6), the processing returns to Step S3. Then, the registered voice data acquisition part 24 acquires, from among a plurality of pieces of registered voice data stored in the registered voice data storage part 23, registered voice data whose similarity score is not calculated.

On the other hand, in a case where it is determined that a similarity score between a feature amount of the voice data to be identified and a feature amount of all pieces of registered voice data is calculated (YES in Step S6), in Step S7, the speaker selection part 27 selects a registered speaker of registered voice data corresponding to a highest similarity score among a plurality of similarity scores calculated by the similarity score calculation part 26.

Next, in Step S8, the similarity score determination part 28 determines whether or not a highest similarity score is higher than the first threshold.

Here, in a case where it is determined that a highest similarity score is equal to or less than the first threshold (NO in Step S8), in Step S9, the error processing part 31 outputs an error message prompting the speaker to be identified to reinput voice data to be identified.

On the other hand, in a case where it is determined that a highest similarity score is higher than the first threshold (YES in Step S8), in Step S10, the speaker determination part 29 determines whether or not a highest similarity score among a plurality of similarity scores calculated by the similarity score calculation part 26 is higher than the second threshold higher than the first threshold.

Here, in a case where it is determined that a highest similarity score is higher than the second threshold (YES in Step S10), in Step S11, the speaker determination part 29 identifies the registered speaker selected by the speaker selection part 27 as the speaker to be identified of the voice data to be identified.

On the other hand, in a case where it is determined that a highest similarity score is equal to or less than the second threshold (NO in Step S10), in Step S12, the speaker determination part 29 determines that the registered speaker selected by the speaker selection part 27 is not the speaker to be identified of the voice data to be identified.

Next, in Step S13, the identification result output part 30 outputs an identification result obtained by the speaker determination part 29. In a case where the selected registered speaker is identified as the speaker to be identified of the voice data to be identified, the identification result output part 30 outputs a message indicating that the speaker to be identified of the voice data to be identified is the selected registered speaker. On the other hand, in a case where it is determined that the selected registered speaker is not the speaker to be identified of the voice data to be identified, the identification result output part 30 outputs a message indicating that the speaker to be identified of the voice data to be identified is not any of a plurality of registered speakers registered in advance.

As described above, a similarity score between voice data to be identified and each of a plurality of pieces of registered voice data is calculated, and whether or not the voice data to be identified is suitable for speaker identification is determined based on the plurality of calculated similarity scores. Then, in a case where it is determined that the voice data to be identified is suitable for speaker identification, it is determined whether or not to identify the selected registered speaker as the speaker to be identified of the voice data to be identified based on a highest similarity score.

A calculation amount of processing for calculating a plurality of similarity scores is smaller than a calculation amount of signal processing for suppressing noise included in the voice data to be identified. Further, since it is determined whether or not the voice data to be identified is suitable for speaker identification based on the plurality of calculated similarity scores, signal processing for suppressing noise that may distort a personal characteristic of a speaker is not performed on the voice data to be identified. Therefore, it is possible to improve accuracy of identifying which of a plurality of speakers registered in advance a speaker to be identified is without increasing a calculation amount.

Note that in the first embodiment, the error processing part 31 outputs an error message prompting the speaker to be identified to reinput the voice data to be identified, but the present disclosure is not particularly limited to this. The identification target voice data acquisition part 21 may acquire the voice data to be identified obtained by cutting out a predetermined section from voice data uttered by the speaker to be identified. At this time, there is a possibility that the voice data to be identified obtained by cutting out a predetermined section does not include voice of the speaker to be identified. In this case, the similarity score determination part 28 determines that the voice data to be identified is not suitable for speaker identification. In view of the above, in a case where the similarity score determination part 28 determines that the voice data to be identified is not suitable for speaker identification, the error processing part 31 may acquire another piece of voice data to be identified obtained by cutting out a section different from the predetermined section from the voice data. Then, the processing returns to Step S2, and the first feature amount calculation part 22 may calculate a feature amount of another piece of voice data to be identified acquired by the error processing part 31. After that, the processing in and after Step S3 may be performed.

As described above, for example, in a case where voice of the speaker to be identified is not included in the voice data to be identified in a section cut out first, it is determined that the voice data to be identified is not suitable for speaker identification. In this case, another piece of voice data to be identified obtained by cutting out a section different from the first section from the voice data is acquired. Therefore, in a case where it is determined that voice data to be identified is not suitable for speaker identification, speaker identification can be performed by using another piece of voice data to be identified.

### Second Embodiment

In the first embodiment, it is determined whether or not a highest similarity score among a plurality of calculated similarity scores is higher than the first threshold, and in a case where it is determined that the highest similarity score is higher than the first threshold, it is determined that the voice data to be identified is suitable for speaker identification. On the other hand, in a second embodiment, a variance value of a plurality of calculated similarity scores is calculated, whether or not the calculated variance value is higher than a first threshold is determined, and in a case where it is determined that the variance value is higher than the first threshold, it is determined that the voice data to be identified is suitable for speaker identification.

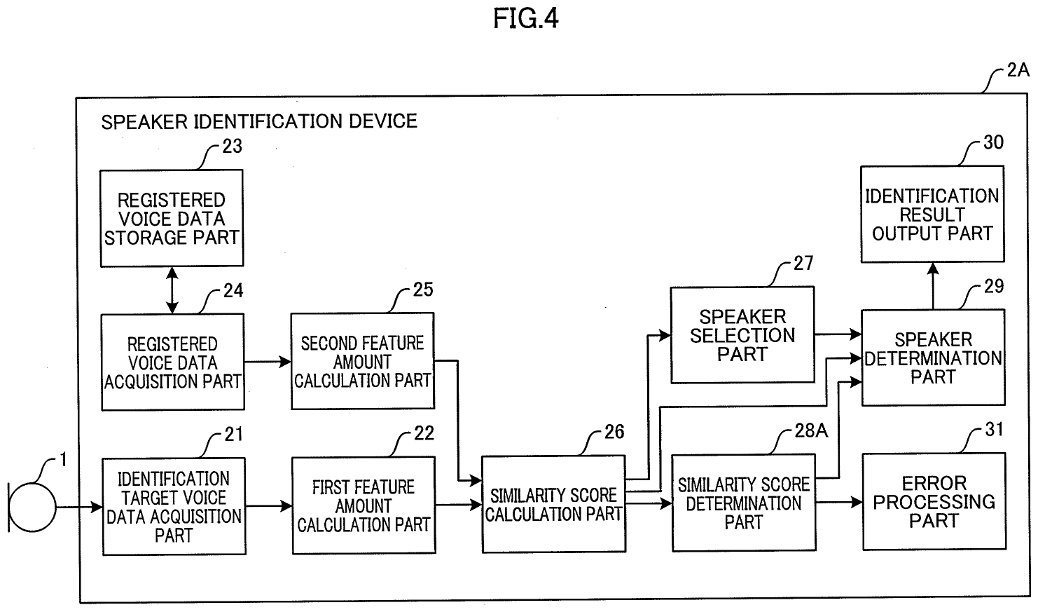

FIG. 4 is a diagram illustrating a configuration of the speaker identification system according to the second embodiment of the present disclosure.

The speaker identification system illustrated in FIG. 4 includes the microphone 1 and a speaker identification device 2A. Note that the speaker identification device 2A may or may not include the microphone 1.

Note that, in the second embodiment, the same configuration as that in the first embodiment will be denoted by the same reference sign as that in the first embodiment, and will be omitted from description.

The speaker identification device 2A includes the identification target voice data acquisition part 21, the first feature amount calculation part 22, the registered voice data storage part 23, the registered voice data acquisition part 24, the second feature amount calculation part 25, the similarity score calculation part 26, the speaker selection part 27, a similarity score determination part 28A, the speaker determination part 29, the identification result output part 30, and the error processing part 31.

The similarity score determination part 28A determines whether or not voice data to be identified is suitable for speaker identification based on a plurality of similarity scores calculated by the similarity score calculation part 26. Here, the similarity score determination part 28A calculates a variance value of a plurality of similarity scores calculated by the similarity score calculation part 26. The similarity score determination part 28A determines whether or not the calculated variance value is higher than a first threshold. In a case of determining that the variance value is higher than the first threshold, the similarity score determination part 28A determines that the voice data to be identified is suitable for speaker identification. On the other hand, in a case of determining that the variance value is equal to or less than the first threshold, the similarity score determination part 28A determines that the voice data to be identified is not suitable for speaker identification.

When voice data to be identified includes noise and the voice data to be identified is not suitable for speaker identification, all similarity scores between the voice data to be identified and a plurality of pieces of registered voice data have a low value. For this reason, when a variance value of a plurality of similarity scores is low, it is possible to determine that voice data to be identified is not suitable for speaker identification.

Next, operation of speaker identification processing of the speaker identification device 2A in the second embodiment of the present disclosure will be described.

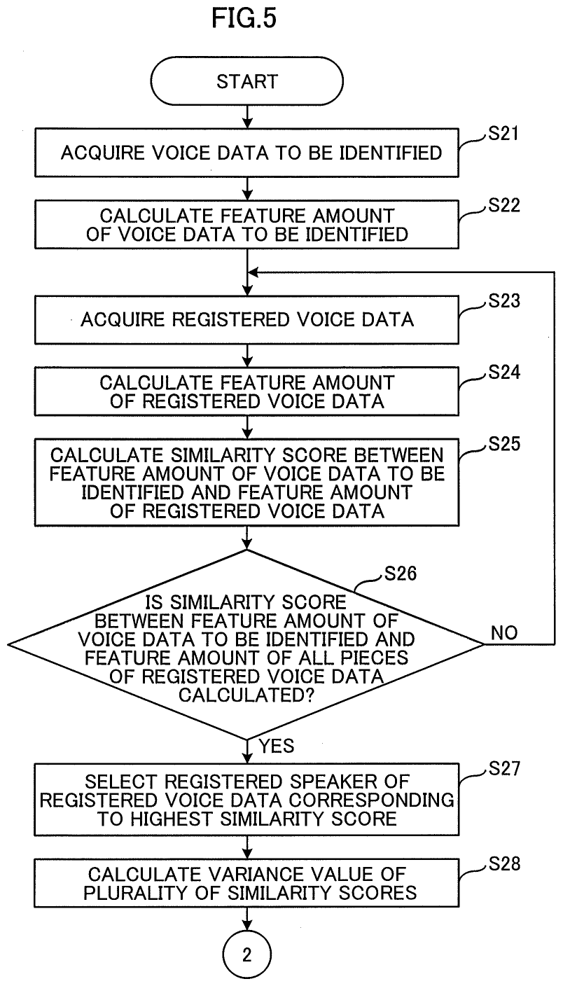

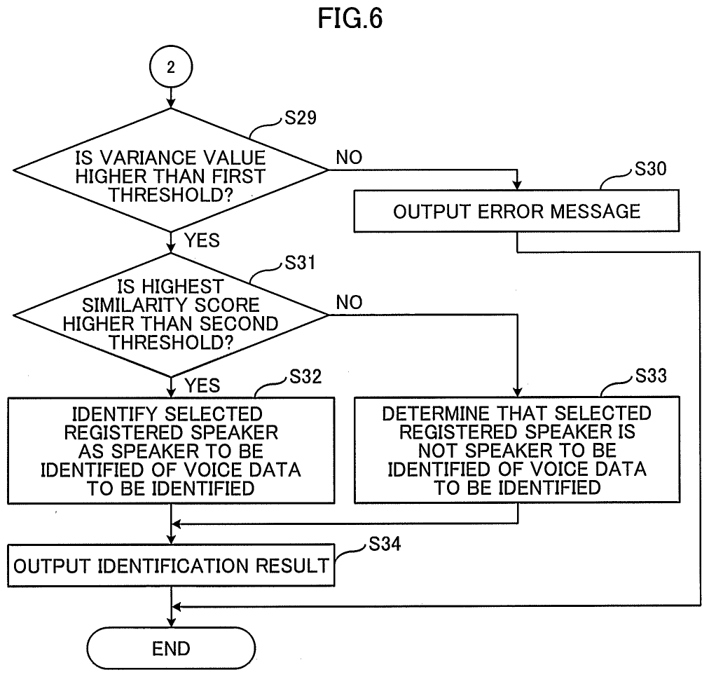

FIG. 5 is a first flowchart for explaining operation of the speaker identification processing of the speaker identification device 2A in the second embodiment, and FIG. 6 is a second flowchart for explaining operation of the speaker identification processing of the speaker identification device 2A in the second embodiment.

Note that processing in Steps S21 to S27 is the same as the processing in Steps S1 to S7 in FIG. 2, and thus will be omitted from description.

Next, in Step S28, the similarity score determination part 28A calculates a variance value of a plurality of similarity scores calculated by the similarity score calculation part 26.

Next, in Step S29, the similarity score determination part 28A determines whether or not the calculated variance value is higher than the first threshold.

Here, in a case where it is determined that the variance value is equal to or less than the first threshold (NO in Step S29), in Step S30, the error processing part 31 outputs an error message prompting the speaker to be identified to reinput voice data to be identified.

On the other hand, in a case where it is determined that the variance value is higher than the first threshold (YES in Step S29), in Step S31, the speaker determination part 29 determines whether or not a highest similarity score among a plurality of similarity scores calculated by the similarity score calculation part 26 is higher than a second threshold higher than the first threshold.

Note that processing in Steps S31 to S34 is the same as the processing in Steps S9 to S12 in FIG. 3, and thus will be omitted from description.

In a case where the voice data to be identified is not suitable for speaker identification, the calculated variance value of a plurality of similarity scores is low. For this reason, by comparing the calculated variance value of a plurality of similarity scores with the first threshold, it is possible to easily determine whether or not the voice data to be identified is suitable for speaker identification.

Note that, in the first embodiment and the second embodiment, the similarity score calculation part 26 calculates a similarity score between a feature amount of voice data to be identified and each feature amount of a plurality of pieces of registered voice data, but the present disclosure is not particularly limited to this. The similarity score calculation part 26 may calculate a similarity score between voice data to be identified and each of a plurality of pieces of registered voice data. In this case, calculation of a feature amount of voice data to be identified and a feature amount of a plurality of pieces of registered voice data is unnecessary.

### Third Embodiment

In the first embodiment, a first similarity score between voice data to be identified and each of a plurality of pieces of first registered voice data in which voice uttered by a plurality of registered speakers to be identified are registered in advance is calculated, and whether or not the voice data to be identified is suitable for speaker identification is determined based on the plurality of calculated first similarity scores. On the other hand, in a third embodiment, a second similarity score between voice data to be identified and each of a plurality of pieces of second registered voice data in which voice uttered by a plurality of other registered speakers other than a plurality of registered speakers to be identified are registered in advance is further calculated, and whether or not the voice data to be identified is suitable for speaker identification is determined based on the plurality of first similarity scores and the plurality of second similarity scores that are calculated.

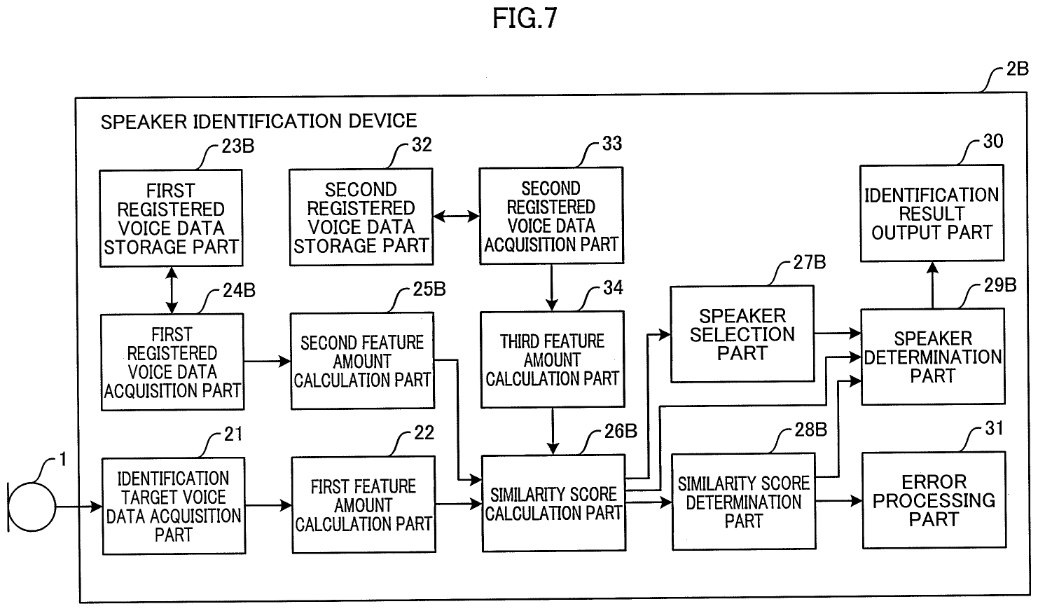

FIG. 7 is a diagram illustrating a configuration of the speaker identification system according to the third embodiment of the present disclosure.

The speaker identification system illustrated in FIG. 7 includes the microphone 1 and a speaker identification device 2B. Note that the speaker identification device 2B may or may not include the microphone 1.

Note that, in the third embodiment, the same configuration as that in the first embodiment will be denoted by the same reference sign as that in the first embodiment, and will be omitted from description.

The speaker identification device 2B includes the identification target voice data acquisition part 21, the first feature amount calculation part 22, a first registered voice data storage part 23B, a first registered voice data acquisition part 24B, a second feature amount calculation part 25B, a similarity score calculation part 26B, a speaker selection part 27B, a similarity score determination part 28B, a speaker determination part 29B, the identification result output part 30, the error processing part 31, a second registered voice data storage part 32, a second registered voice data acquisition part 33, and a third feature amount calculation part 34.

Note that the identification target voice data acquisition part 21, the first feature amount calculation part 22, the first registered voice data acquisition part 24B, the second feature amount calculation part 25B, the similarity score calculation part 26B, the speaker selection part 27B, the similarity score determination part 28B, the speaker determination part 29B, the identification result output part 30, the error processing part 31, the second registered voice data acquisition part 33, and the third feature amount calculation part 34 are realized by a processor. The first registered voice data storage part 23B and the second registered voice data storage part 32 are realized by a memory.

The first registered voice data storage part 23B stores in advance a plurality of pieces of first registered voice data associated with information on a speaker. The plurality of pieces of first registered voice data indicate voice uttered by a plurality of registered speakers to be identified. The plurality of pieces of first registered voice data are the same as a plurality of pieces of registered voice data in the first embodiment.

The first registered voice data acquisition part 24B acquires a plurality of pieces of first registered voice data registered in advance in the first registered voice data storage part 23B.

The second feature amount calculation part 25B calculates a feature amount of a plurality of pieces of first registered voice data acquired by the first registered voice data acquisition part 24B. The feature amount is, for example, an i-vector.

The second registered voice data storage part 32 stores a plurality of pieces of second registered voice data in advance. The plurality of pieces of second registered voice data indicate voice uttered by a plurality of registered speakers other than a plurality of registered speakers to be identified. The plurality of pieces of second registered voice data do not include noise and include only voice.

The second registered voice data acquisition part 33 acquires a plurality of pieces of second registered voice data registered in advance in the second registered voice data storage part 32.

The third feature amount calculation part 34 calculates a feature amount of a plurality of pieces of second registered voice data acquired by the second registered voice data acquisition part 33. The feature amount is, for example, an i-vector.

The similarity score calculation part 26B calculates a first similarity score between a feature amount of voice data to be identified and each feature amount of a plurality of pieces of first registered voice data, and calculates a second similarity score between a feature amount of the voice data to be identified and each feature amount of a plurality of pieces of second registered voice data.

The speaker selection part 27B selects a registered speaker of first registered voice data corresponding to a highest first similarity score among a plurality of first similarity scores calculated by the similarity score calculation part 26B.

The similarity score determination part 28B determines whether or not voice data to be identified is suitable for speaker identification based on a plurality of first similarity scores and a plurality of second similarity scores calculated by the similarity score calculation part 26B. Here, the similarity score determination part 28B determines whether or not a highest first similarity score or second similarity score among a plurality of first similarity scores and a plurality of second similarity scores calculated by the similarity score calculation part 26B is higher than a first threshold. In a case of determining that the highest first similarity score or second similarity score is higher than the first threshold, the similarity score determination part 28B determines that voice data to be identified is suitable for speaker identification. On the other hand, in a case of determining that the highest first similarity score or second similarity score is equal to or less than the first threshold, the similarity score determination part 28B determines that the voice data to be identified is not suitable for speaker identification.

In a case where voice data to be identified is speaker identifiable, there is a high possibility that the voice data to be identified is similar to any registered voice data of a large number of pieces of registered voice data. In view of the above, the second registered voice data storage part 32 in the third embodiment stores in advance a plurality of pieces of second registered voice data that do not include noise and include clean voice uttered by a plurality of other registered speakers other than a plurality of registered speakers to be identified. The number of a plurality of other registered speakers is, for example, 100, and the number of a plurality of pieces of second registered voice data is, for example, 100. If there is second registered voice data similar to voice data to be identified among a plurality of pieces of second registered voice data, it can be determined that the voice data to be identified is speaker identifiable.

In a case where voice data to be identified is determined to be suitable for speaker identification by the similarity score determination part 28B, the speaker determination part 29B determines whether or not to identify a registered speaker selected by the speaker selection part 27B as a speaker to be identified of the voice data to be identified based on a highest first similarity score. Here, the speaker determination part 29B determines whether or not a highest first similarity score among a plurality of first similarity scores calculated by the similarity score calculation part 26B is higher than a second threshold higher than the first threshold. In a case of determining that the highest first similarity score is higher than the second threshold, the speaker determination part 29B determines to identify a registered speaker selected by the speaker selection part 27B as a speaker to be identified of the voice data to be identified. On the other hand, in a case of determining that the highest first similarity score is equal to or less than the second threshold, the speaker determination part 29B determines not to identify a registered speaker selected by the speaker selection part 27B as a speaker to be identified of the voice data to be identified.

Note that, in the third embodiment, in a case where voice data to be identified is determined to be suitable for speaker identification by the similarity score determination part 28B, the speaker determination part 29B may identify a registered speaker selected by the speaker selection part 27B as a speaker to be identified of the voice data to be identified. In this case, the speaker determination part 29B may identify a registered speaker selected by the speaker selection part 27B as a speaker to be identified of the voice data to be identified without determining whether or not a highest first similarity score among a plurality of first similarity scores calculated by the similarity score calculation part 26B is higher than the second threshold.

Next, operation of speaker identification processing of the speaker identification device 2B in the third embodiment of the present disclosure will be described.

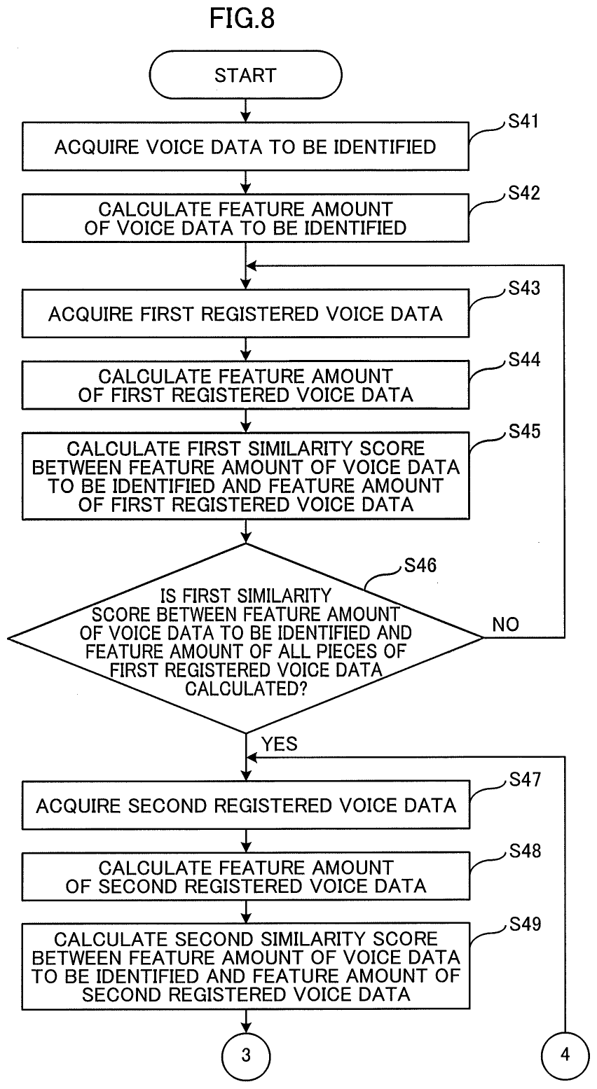

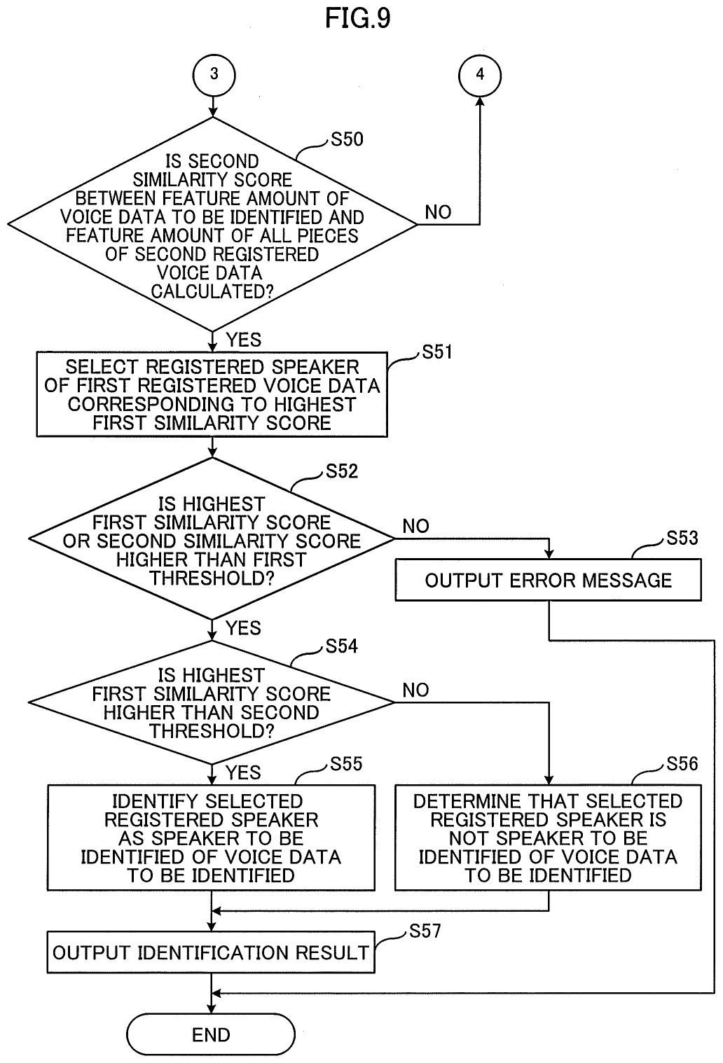

FIG. 8 is a first flowchart for explaining operation of the speaker identification processing of the speaker identification device 2B in the third embodiment, and FIG. 9 is a second flowchart for explaining operation of the speaker identification processing of the speaker identification device 2B in the third embodiment.

Note that processing in Step S41 and Step S42 is the same as the processing in Step S1 and Step S2 of FIG. 2, and will be omitted from description.

Next, in Step S43, the first registered voice data acquisition part 24B acquires first registered voice data from the first registered voice data storage part 23B. At this time, the first registered voice data acquisition part 24B acquires one piece of first registered voice data from a plurality of pieces of first registered voice data that are registered in the first registered voice data storage part 23B.

Next, in Step S44, the second feature amount calculation part 25B calculates a feature amount of the first registered voice data acquired by the first registered voice data acquisition part 24B.

Next, in Step S45, the similarity score calculation part 26B calculates a first similarity score between a feature amount of the voice data to be identified and a feature amount of the first registered voice data.

Next, in Step S46, the similarity score calculation part 26B determines whether or not a first similarity score between a feature amount of the voice data to be identified and a feature amount of all pieces of first registered voice data stored in the first registered voice data storage part 23B is calculated. Here, in a case where it is determined that a first similarity score between a feature amount of the voice data to be identified and a feature amount of all pieces of first registered voice data is not calculated (NO in Step S46), the processing returns to Step S43. Then, the first registered voice data acquisition part 24B acquires, from among a plurality of pieces of first registered voice data stored in the first registered voice data storage part 23B, first registered voice data whose first similarity score is not calculated.

On the other hand, in a case where it is determined that the first similarity score between the feature amount of the voice data to be identified and a feature amount of all pieces of the first registered voice data is calculated (YES in Step S46), in Step S47, the second registered voice data acquisition part 33 acquires second registered voice data from the second registered voice data storage part 32. At this time, the second registered voice data acquisition part 33 acquires one piece of second registered voice data from a plurality of pieces of second registered voice data that are registered in the second registered voice data storage part 32.

Next, in Step S48, the third feature amount calculation part 34 calculates a feature amount of the second registered voice data acquired by the second registered voice data acquisition part 33.

Next, in Step S49, the similarity score calculation part 26B calculates a second similarity score between a feature amount of the voice data to be identified and a feature amount of the second registered voice data.

Next, in Step S50, the similarity score calculation part 26B determines whether or not a second similarity score between a feature amount of the voice data to be identified and a feature amount of all pieces of second registered voice data stored in the second registered voice data storage part 32 is calculated. Here, in a case where it is determined that a second similarity score between a feature amount of the voice data to be identified and a feature amount of all pieces of second registered voice data is not calculated (NO in Step S50), the processing returns to Step S47. Then, the second registered voice data acquisition part 33 acquires, from among a plurality of pieces of second registered voice data stored in the second registered voice data storage part 32, second registered voice data whose second similarity score is not calculated.

On the other hand, in a case where it is determined that a second similarity score between a feature amount of the voice data to be identified and a feature amount of all pieces of second registered voice data is calculated (YES in Step S50), in Step S51, the speaker selection part 27B selects a registered speaker of first registered voice data corresponding to a highest first similarity score among a plurality of first similarity scores calculated by the similarity score calculation part 26B.

Next, in Step S52, the similarity score determination part 28B determines whether or not the highest first similarity score or second similarity score is higher than the first threshold.

Here, in a case where it is determined that the highest first similarity score or second similarity score is equal to or less than the first threshold (NO in Step S52), in Step S53, the error processing part 31 outputs an error message prompting the speaker to be identified to reinput voice data to be identified.

On the other hand, in a case where it is determined that the highest first similarity score or second similarity score is higher than the first threshold (YES in Step S52), in Step S54, the speaker determination part 29B determines whether or not a highest first similarity score among a plurality of first similarity scores calculated by the similarity score calculation part 26B is higher than the second threshold higher than the first threshold.

Here, in a case where it is determined that the highest first similarity score is higher than the second threshold (YES in Step S54), in Step S55, the speaker determination part 29B identifies the registered speaker selected by the speaker selection part 27B as the speaker to be identified of the voice data to be identified.

On the other hand, in a case where it is determined that the highest first similarity score is equal to or less than the second threshold (NO in Step S54), in Step S56, the speaker determination part 29B determines that the registered speaker selected by the speaker selection part 27B is not the speaker to be identified of the voice data to be identified.

Note that processing in Step S57 is the same as the processing in Step S12 illustrated in FIG. 3, and thus will be omitted from description.

In a case where voice data to be identified is speaker identifiable, there is a high possibility that the voice data to be identified is similar to any of a plurality of pieces of registered voice data as the number of pieces of a plurality of registered voice data increases. In view of the above, it is possible to reliably determine whether or not the voice data to be identified is suitable for speaker identification by using not only a plurality of first similarity scores calculated from a plurality of pieces of first registered voice data in which voice uttered by a plurality of registered speakers to be identified are registered in advance, but also a plurality of second similarity scores calculated from a plurality of pieces of second registered voice data in which voice uttered by a plurality of other registered speakers other than a plurality of registered speakers to be identified are registered in advance.

Note that, in the third embodiment, the similarity score determination part 28B determines whether or not voice data to be identified is suitable for speaker identification based on a plurality of first similarity scores and a plurality of second similarity scores calculated by the similarity score calculation part 26B. However, the present disclosure is not particularly limited to this. The similarity score determination part 28B may determines whether or not voice data to be identified is suitable for speaker identification based on a plurality of second similarity scores calculated by the similarity score calculation part 26B. At this time, the similarity score determination part 28B may determine whether or not a highest second similarity score among a plurality of second similarity scores calculated by the similarity score calculation part 26B is higher than the first threshold. In a case of determining that the highest second similarity score is higher than the first threshold, the similarity score determination part 28B may determine that the voice data to be identified is suitable for speaker identification. On the other hand, in a case of determining that the highest second similarity score is equal to or less than the first threshold, the similarity score determination part 28B may determine that the voice data to be identified is not suitable for speaker identification.

Note that, in the third embodiment, the similarity score calculation part 26B calculates a first similarity score between a feature amount of voice data to be identified and each feature amount of a plurality of pieces of first registered voice data, and calculates a second similarity score between a feature amount of the voice data to be identified and each feature amount of a plurality of pieces of second registered voice data. However, the present disclosure is not particularly limited to this. The similarity score calculation part 26B may calculate a first similarity score between voice data to be identified and each of the plurality of pieces of first registered voice data, and may calculate a second similarity score between the voice data to be identified and each of the plurality of pieces of second registered voice data. In this case, calculation of a feature amount of the voice data to be identified, a feature amount of the plurality of pieces of first registered voice data, and a feature amount of the plurality of pieces of second registered voice data becomes unnecessary.

Note that in each of the embodiments, each constituent element may include dedicated hardware or may be realized by execution of a software program suitable for each constituent element. Each constituent element may be realized by a program execution part, such as a CPU or a processor, reading and executing a software program recorded in a recording medium such as a hard disk or a semiconductor memory. Further, the program may be carried out by another independent computer system by being recorded in a recording medium and transferred or by being transferred via a network.

Some or all functions of the devices according to the embodiment of the present disclosure are realized as large scale integration (LSI), which is typically an integrated circuit. These functions may be individually integrated into one chip, or may be integrated into one chip so as to include some or all functions. Further, circuit integration is not limited to LSI, and may be realized by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Further, some or all functions of the device according to the embodiment of the present disclosure may be realized by a processor such as a CPU executing a program.

Further, all numbers used above are illustrated to specifically describe the present disclosure, and the present disclosure is not limited to the illustrated numbers.

Further, order in which steps illustrated in the above flowchart are executed is for specifically describing the present disclosure, and may be any order other than the above order as long as a similar effect is obtained. Further, some of the above steps may be executed simultaneously (in parallel) with another step.

Since the technique according to the present disclosure enables improvement in accuracy of identifying which of a plurality of speakers registered in advance a speaker to be identified is, without increasing a calculation amount, the technique is useful as a technique for identifying a speaker.

1. A speaker identification method in a computer, the speaker identification method comprising:
acquiring voice data to be identified;
acquiring a plurality of pieces of registered voice data that are registered in advance;
calculating a similarity between the voice data to be identified and each of the plurality of pieces of registered voice data;
selecting a registered speaker of registered voice data corresponding to a highest similarity from among a plurality of calculated similarities;
determining, based on the plurality of calculated similarities, whether or not the voice data to be identified is suitable for speaker identification;
determining, based on the highest similarity, whether or not to identify the selected registered speaker as a speaker to be identified of the voice data to be identified in a case where the voice data to be identified is determined to be suitable for the speaker identification; and
outputting an identification result.

2. The speaker identification method according to claim 1, wherein in determination as to whether or not the voice data to be identified is suitable for the speaker identification, whether or not a highest similarity among the plurality of calculated similarities is higher than a first threshold is determined, and in a case where the highest similarity is determined to be higher than the first threshold, the voice data to be identified is determined to be suitable for the speaker identification.

3. The speaker identification method according to claim 1, wherein in determination as to whether or not the voice data to be identified is suitable for the speaker identification, a variance value of the plurality of calculated similarities is calculated, whether or not the calculated variance value is higher than a first threshold is determined, and in a case where the variance value is determined to be higher than the first threshold, the voice data to be identified is determined to be suitable for the speaker identification.

4. The speaker identification method according to claim 2, wherein in determination as to whether or not to identify the selected registered speaker as a speaker to be identified of the voice data to be identified, whether or not a highest similarity among the plurality of calculated similarities is higher than a second threshold higher than the first threshold is determined, and in a case where the highest similarity is determined to be higher than the second threshold, the selected registered speaker is identified as the speaker to be identified of the voice data to be identified.

5. The speaker identification method according to claim 1, wherein
the plurality of pieces of registered voice data include a plurality of pieces of first registered voice data in which voice uttered by a plurality of registered speakers to be identified is registered in advance, and a plurality of pieces of second registered voice data in which voice uttered by a plurality of other registered speakers other than the plurality of registered speakers to be identified is registered in advance,
in calculation of the similarity, a first similarity between the voice data to be identified and each of the plurality of pieces of first registered voice data is calculated, and a second similarity between the voice data to be identified and each of the plurality of pieces of second registered voice data is calculated,
in selection of the registered speaker, a registered speaker of first registered voice data corresponding to a highest first similarity among a plurality of calculated first similarities is selected, and
in determination as to whether or not the voice data to be identified is suitable for the speaker identification, whether or not a highest first similarity or a highest second similarity among the plurality of calculated first similarities and the plurality of calculated second similarities is higher than a first threshold is determined, and in a case where the highest first similarity or the highest second similarity is determined to be higher than the first threshold, the voice data to be identified is determined to be suitable for the speaker identification.

6. The speaker identification method according to claim 5, wherein the plurality of pieces of second registered voice data do not include noise and include only the voice uttered by the other registered speakers.

7. The speaker identification method according to claim 5, wherein in determination as to whether or not to identify the selected registered speaker as a speaker to be identified of the voice data to be identified, whether or not a highest first similarity among the plurality of calculated first similarities is higher than a second threshold higher than the first threshold is determined, and in a case where the highest first similarity is determined to be higher than the second threshold, the selected registered speaker is identified as the speaker to be identified of the voice data to be identified.

8. The speaker identification method according to claim 1, further comprising outputting an error message prompting the speaker to be identified to reinput the voice data to be identified in a case where the voice data to be identified is determined not to be suitable for the speaker identification.

9. The speaker identification method according to claim 1, wherein
in acquisition of the voice data to be identified, the voice data to be identified obtained by cutting out a predetermined section from voice data uttered by the speaker to be identified is acquired, and
the speaker identification method further comprises acquiring another piece of voice data to be identified obtained by cutting out a section different from the predetermined section from the voice data in a case where the voice data to be identified is determined not to be suitable for the speaker identification.

10. A speaker identification device comprising:
an identification target voice data acquisition part that acquires voice data to be identified;
a registered voice data acquisition part that acquires a plurality of pieces of registered voice data that are registered in advance;
a calculation part that calculates a similarity between the voice data to be identified and each of the plurality of pieces of registered voice data;
a selection part that selects a registered speaker of registered voice data corresponding to a highest similarity from among a plurality of calculated similarities;
a similarity determination part that determines, based on the plurality of calculated similarities, whether or not the voice data to be identified is suitable for speaker identification;
a speaker determination part that determines, based on the highest similarity, whether or not to identify the selected registered speaker as a speaker to be identified of the voice data to be identified in a case where the voice data to be identified is determined to be suitable for the speaker identification; and
an output part that outputs an identification result.

11. A non-transitory computer readable recording medium storing a speaker identification program that causes a computer to function to:
acquire voice data to be identified;
acquire a plurality of pieces of registered voice data that are registered in advance;
calculate a similarity between the voice data to be identified and each of the plurality of pieces of registered voice data;
select a registered speaker of registered voice data corresponding to a highest similarity from among a plurality of calculated similarities;
determine, based on the plurality of calculated similarities, whether or not the voice data to be identified is suitable for speaker identification;
determine, based on the highest similarity, whether or not to identify the selected registered speaker as a speaker to be identified of the voice data to be identified in a case where the voice data to be identified is determined to be suitable for the speaker identification; and
output an identification result.
